(19) United States
(12) Patent Application Publication
(10) Pub. No.: US 2026/0244448 A1
(43) Pub. Date: Aug. 20, 2026

(54) ARTIFICIAL INTELLIGENCE PROCESSOR

(71) Applicant: Taiwan Semiconductor Manufacturing Company, Ltd., Hsinchu (TW)

(72) Inventor: Meng-Sheng Chang, Hsinchu (TW)

(21) Appl. No.: 19/054,296

(22) Filed: Feb. 14, 2025

(51) Int. Cl. G06F 9/38

(52) U.S. Cl. CPC G06F 9/3818; G06F 9/3885

(57) ABSTRACT

An Artificial Intelligence (AI) processor is provided. The AI processor include a compute circuit having a plurality of dies. Each of the plurality of dies includes a plurality of compute modules. Each of the plurality of compute modules are connectable to a first power line through a first fuse element and a second power line through a second fuse element. A control circuit is connected to the compute circuit. The control circuit burns a first number of first fuse elements connected between the first power line and a first number of compute modules of the plurality of compute modules. The control circuit further burns a second number of second fuse elements connected between the second power line and a second number of compute modules of the plurality of compute modules.

### BACKGROUND

Artificial Intelligence (AI) processors include multiple compute modules designed to perform computations associated with an AI algorithm in parallel. These modules are connected to a shared power line, which typically links multiple dies and each compute modules on those dies. When once one or more modules or dies fail, it results in increased power consumption and reduced computing performance. For instance, a failed module may allow higher current to flow through it while contributing no computational output.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram illustrating an example Artificial Intelligence (AI) processor in accordance with some embodiments.

FIG. 2 is a block diagram illustrating a first example AI processor with multiple power lines in accordance with some embodiments.

FIG. 3 is a block diagram illustrating a second example AI processor with multiple frequency lines in accordance with some embodiments.

FIG. 4 is a flow diagram illustrating a method 400 for programming an AI processor in accordance with some embodiments.

FIG. 5 is a flow diagram illustrating another method for programming an AI processor in accordance with some embodiments.

FIG. 6 is a flow diagram illustrating yet another method for programming an AI processor in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

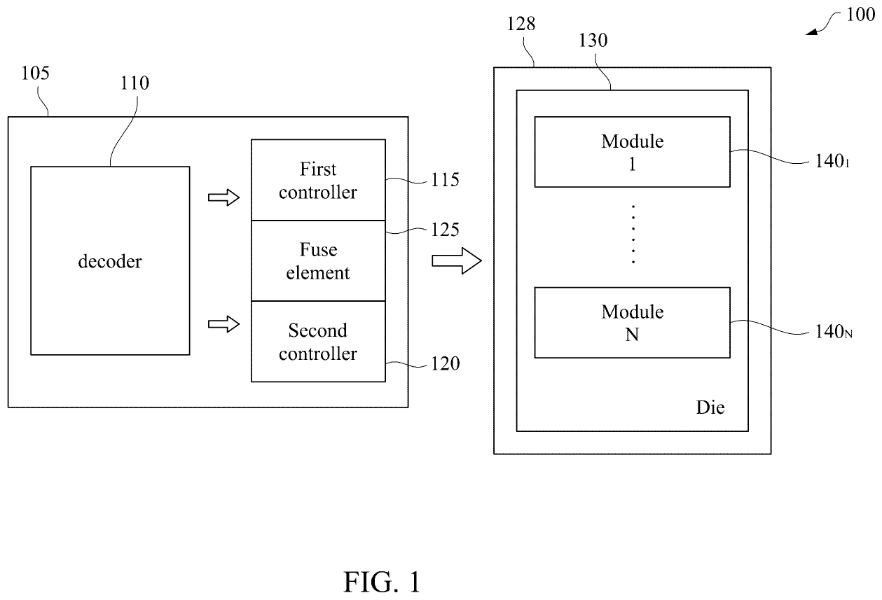

The disclosure provides Artificial Intelligence (AI) processors with configurable power mode and frequency mode. FIG. 1 is a block diagram illustrating an example AI processor 100 in accordance with some embodiments. AI processor 100 may be used to execute an AI algorithm or portions of an AI algorithm. As shown in FIG. 1, AI processor 100 includes a control circuit 105. Control circuit 105 includes a decoder 110, a first controller 115, a second controller 120, and a fuse elements 125. AI processor 100 further includes a compute circuit 128. Compute circuit 128 includes at least one die 130. Die 130 includes a plurality of compute modules 140₁, . . . , 140_{N} (collectively 140).

Each of plurality of compute modules 140 may include a circuit that is configured or programmed to carry out a compute function of an AI algorithm. For example, each compute module may be configured to calculate or update a value of a variable associated with the AI algorithm. Compute circuit 128 may be programmed to operate at different power levels and at different clock frequencies.

Control circuit 105 is configured to control operations of compute circuit 128. For example, and as discussed in greater detail in the following sections of the disclosure, control circuit 105 may configure compute circuit 128 to operate at different power levels or different power modes and at different frequencies or clock frequencies. Decoder 110, first controller 115, second controller 120, and fuse elements 125 may be used to configure compute circuit 128 to operate at different power levels and at different frequencies. For example, first controller 115 may select a power line from a plurality of power lines and a frequency line from a plurality of frequency lines. Second controller 120 may determine which fuse elements 125 to burn with first controller 115 based on the selected power line and the frequency line. Fuse elements 125 may selectively be burned to operate compute circuit 128 at different power levels and at different frequencies.

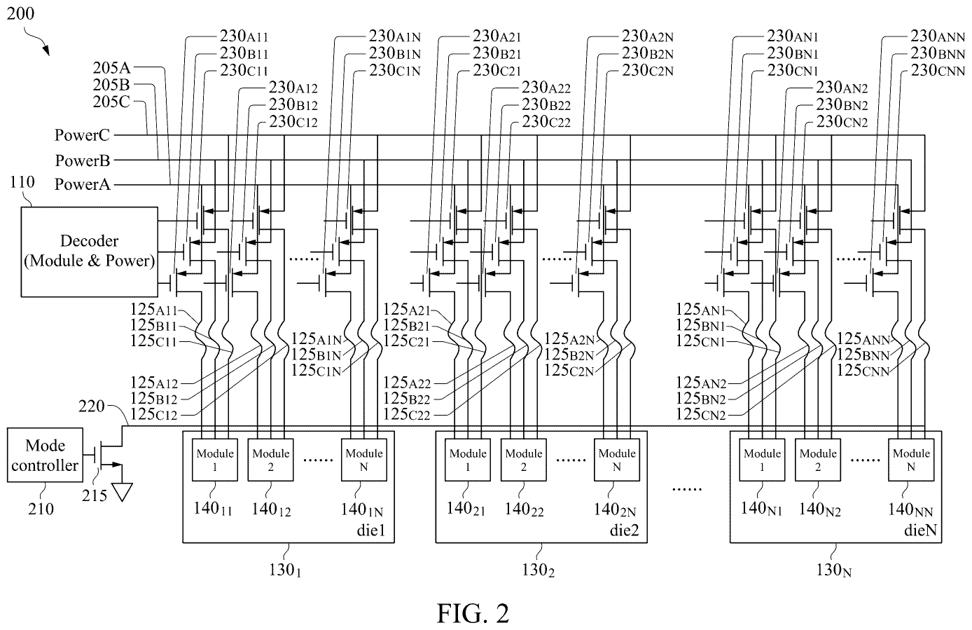

FIG. 2 is a block diagram illustrating a first example AI processor 200 with multiple power lines in accordance with some embodiments. AI processor 200 may be same as AI processor 100 of FIG. 1. As shown in FIG. 2, AI processor 200 may include a plurality of power lines, for example, a first power line 205A (Power A), a second power line 205B (Power B), and a third power line 205C (Power C). Each of first power line 205A, second power line 205B, and third power line 205C may operate AI processor 200 at a different power level. In addition, each of first power line 205A, second power line 205B, and third power line 205C may provide a same voltage level or a different voltage level. Although AI processor 200 is shown to include three power lines, it can include any number of power lines greater than one, for example, 2, 3, 4, 5, etc.

In addition, and as shown in FIG. 2, AI processor 200 may include a plurality of dies, for example, a first die 130₁, a second die 130₂, . . . , and an nth die 130_{N}. Each of the plurality of dies may include plurality of compute modules. For example, first die 130₁ may include a first compute module 140₁₁, a second compute module 140₁₂, . . . , and an nth compute module 140_{1N}. Similarly, second die 130₂ may include a first compute module 140₂₁, a second compute module 140₂₂, . . . , and an nth compute module 140_{2N}. Finally, nth die 130_{N} may include a first compute module 140_{N1}, a second compute module 140_{N2}, . . . , and an nth compute module 140_{NN}.

Each compute module of each die is connectable to each of the plurality of power lines via a switch and a fuse element. For example, first compute module 140₁₁ of first die 130₁ is connectable: to first power line 205A via a first fuse element 125_{A11} and a first switch 230_{A11}, to second power line 205B via a second fuse element 125_{B11} and a second switch 230_{B11}, and to third power line 205C via a third fuse element 125_{C11} and a third switch 230_{C11}. In addition, second compute module 140₁₂ of first die 130₁ is connectable: to first power line 205A via a first fuse element 125_{A12} and a first switch 230_{A12}, to second power line 205B via a second fuse element 125_{B12} and a second switch 230_{B12}, and to third power line 205C via a third fuse element 125_{C12} and a third switch 230_{C12}. Moreover, nth compute module 140_{1N} of first die 130₁ is connectable: to first power line 205A via a first fuse element 125_{A1N} and a first switch 230_{A1N}, to second power line 205B via a second fuse element 125_{B1N} and a second switch 230_{B1N}, and to a third power line 205C via a third fuse element 125_{C1N} and a third switch 230_{C1N}.

First compute module 140₂₁ of second die 130₂ is connectable: to first power line 205A via a first fuse element 125_{A21} and a first switch 230_{A21}, to second power line 205B via a second fuse element 125_{B21} and a second switch 230_{B21}, and to third power line 205C via a third fuse element 125_{C21} and a third switch 230_{C21}. In addition, second compute module 140₂₂ of second die 130₂ is connectable: to first power line 205A via a first fuse element 125_{A22} and a first switch 230_{A22}, to second power line 205B via a second fuse element 125_{B22} and a second switch 230_{B22}, and to third power line 205C via a third fuse element 125_{C22} and a third switch 230_{C22}. Moreover, nth compute module 140_{2N} of second die 130₂ is connectable: to first power line 205A via a first fuse element 125_{A2N} and a first switch 230_{A2N}, to second power line 205B via a second fuse element 125_{B2N} and a second switch 230_{B2N}, and to third power line 205C via a third fuse element 125_{C2N} and a third switch 230_{C2N}.

First compute module 140_{N1} of nth die 130_{N} is connectable: to first power line 205A via a first fuse element 125_{AN1} and a first switch 230_{AN1}, to second power line 205B via a second fuse element 125_{BN1} and a second switch 230_{BN1}, and to third power line 205C via a third fuse element 125_{CN1} and a third switch 230_{CN1}. In addition, second compute module 140_{N2} of nth die 130_{N} is connectable: to first power line 205A via a first fuse element 125_{AN2} and a first switch 230_{AN2}, to second power line 205B via a second fuse element 125_{BN2} and a second switch 230_{BN2}, and to third power line 205C via a third fuse element 125_{CN2} and a third switch 230_{CN2}. Moreover, nth compute module 140_{NN} of nth die 130_{N} is connectable: to first power line 205A via a first fuse element 125_{ANN} and a first switch 230_{ANN}, to second power line 205B via a second fuse element 125_{BNN} and a second switch 230_{BNN}, and to third power line 205C via a third fuse element 125_{CNN} and a third switch 230_{CNN}.

AI processor 200 further includes mode controller 210, programming circuit 215, and programming line 220. Mode controller 210, programming circuit 215, and programming line 220 may determine and burn one or more of fuse elements for programming of AI processor 200. During programming, decoder 110 may selectively switch on a corresponding switch and burn a corresponding fuse element. Burning of a fuse element may disable or disconnect a corresponding compute module from a corresponding power line. For example, burning first fuse element 125_{A11} of first die 130₁ disconnects first compute module 140₁₁ of first die 130₁ from first power line 205A. First fuse element 125_{A11} of first die 130₁ is burned by applying a programming voltage at first power line 205A and a gate voltage at a gate of first switch 230_{A11} and at a gate of programming circuit 215. This causes a high current to pass through first fuse element 125_{A11} to the ground via programming circuit 215 and program line 220 and thereby burning first fuse element 125_{A11}. Decoder 110 is configured to select first switch 230_{A11} and apply the gate voltage at the gate of first switch 230_{A11}. Mode controller 210 may apply the gate voltage at the gate of programming circuit 215 to connect first fuse element 125_{A11} to the ground.

In example, first power line 205A may be programmed for a high-power operation or a high-power mode, second power line 205B may be programmed for a medium power operation or a medium power mode, and third power line 205C may be programmed for a low power operation or a low power mode. In the high-power mode, each of the plurality of compute modules of each of the plurality of dies are connected to first power line 205A and none of the fuse elements are burned out. In the medium power mode, 95% of the plurality of compute modules are connected to second power line 205B. For the medium power mode, a fuse element corresponding to each of the remaining 5% of the plurality of compute modules are burned. In the low power mode, 80% of the plurality of compute modules are connected to third power line 205C. For the low power mode, a fuse element corresponding to each of the remaining 20% of the plurality of compute modules are burned. During the computation stage, one of first power line 205A, second power line 205B, and third power line 205C is charged to a compute voltage based on a computation power requirement.

In a compute mode, control circuit 105 may apply a compute voltage to one of the plurality of power lines based on a power mode selected for AI processor 200. For example, for the high-power mode, control circuit 105 may apply the compute voltage to first power line 205A. The compute voltage may be lower than the programming voltage applied to the plurality of power lines. In compute mode, mode controller 210 may not apply the gate voltage at the gate of programming circuit 215.

In example embodiments, each fuse element may be a one transistor one resistor (1T1R) circuit, a plurality of transistors and a plurality of resistors (NTNR) circuit, one transistor one capacitor (1T1C) circuit, or a plurality of transistors and a plurality of capacitors (NTNC) circuit. In some example embodiments, each fuse element may be a metal line, a poly, a Resistive Random Access Memory (RRAM), a Magnetic Random Access Memory (MRAM), etc. Switches may include an n-channel Metal Oxide Semiconductor (NMOS), a p-channel Metal Oxide Semiconductor (PMOS), etc. Control device 105 (that is, decoder 110, mode controller 210, etc.) may include NMOS, PMOS, or a combination of NMOS and PMOS. Programming circuit 215 may be a switch for example, a PMOS switch.

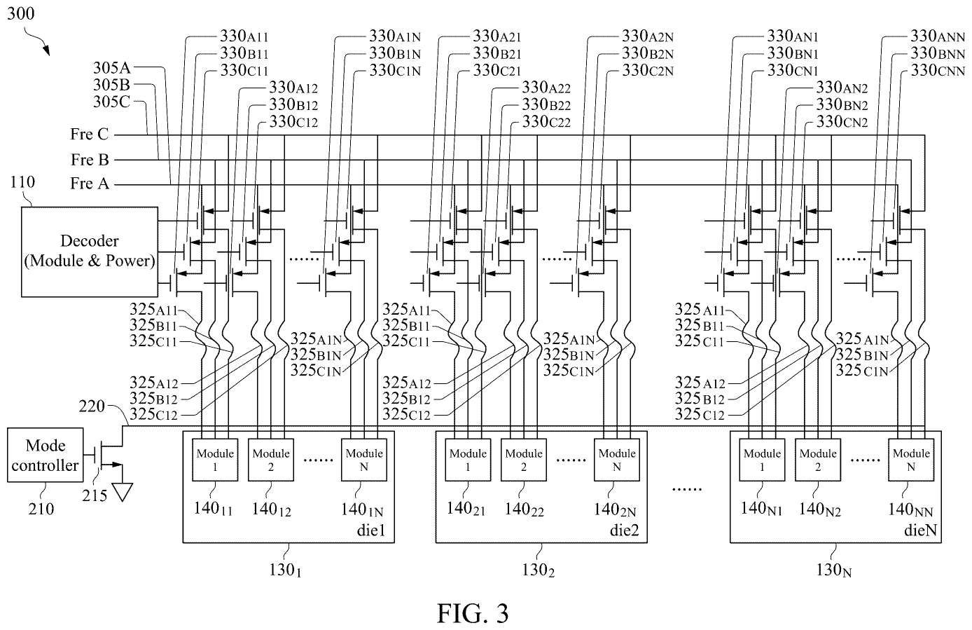

FIG. 3 is a block diagram illustrating a second example AI processor 300 with multiple frequency lines in accordance with some embodiments. AI processor 300 may be same as AI processor 100 of FIG. 1. As shown in FIG. 3, AI processor 300 may include multiple frequency lines, for example, a first frequency line 305A (Fre A), a second frequency line 305B (Fre B), and a third frequency line 305C (Fre C). Each of first frequency line 305A, second frequency line 305B, and third frequency line 305C may provide different frequency of operation for an associated compute module. Although AI processor 300 is shown to include three frequency lines, it can include any number of frequency lines greater than one, for example, 2, 3, 4, 5, etc.

In addition, and as shown in FIG. 3, AI processor 300 may include the plurality of dies, for example, first die 130₁, second die 130₂, . . . , and nth die 130_{N}. Each of the plurality of dies may include plurality of compute modules. For example, first die 130₁ may include first compute module 140₁₁, second compute module 140₁₂, . . . , and nth compute module 140_{1N}. Similarly, second die 130₂ may include first compute module 140₂₁, second compute module 140₂₂, . . . , and nth compute module 140_{2N}. Finally, nth die 130_{N} may include first compute module 140_{N1}, second compute module 140_{N2}, . . . , and nth compute module 140_{NN}.

Each compute module of each die is connectable to each of the plurality of frequency lines via a switch and a fuse element. For example, first compute module 140₁₁ of first die 130₁ is connectable: to first frequency line 305A via a first fuse element 325_{A11} and a first switch 330_{A11}, to second frequency line 305B via a second fuse element 325_{B11} and a second switch 330_{B11}, and to third frequency line 305C via a third fuse element 325_{C11} and a third switch 330_{C11}. In addition, second compute module 140₁₂ of first die 130₁ is connectable: to first frequency line 305A via a first fuse element 325_{A12} and a first switch 330_{A12}, to second frequency line 305B via a second fuse element 325_{B12} and a second switch 330_{B12}, and to third frequency line 305C via a third fuse element 325_{C12} and a third switch 330_{C12}. Moreover, nth compute module 140_{1N} of first die 130₁ is connectable: to first frequency line 305A via a first fuse element 325_{A1N} and a first switch 330_{A1N}, to second frequency line 305B via a second fuse element 325_{B1N} and a second switch 330_{B1N}, and to third frequency line 305C via a third fuse element 325_{C1N} and a third switch 330_{C1N}.

First compute module 140₂₁ of second die 130₂ is connectable: to first frequency line 305A via a first fuse element 325_{A21} and a first switch 330_{A21}, to second frequency line 305B via a second fuse element 325_{B21} and a second switch 330_{B21}, and to third frequency line 305C via a third fuse element 325_{C21} and a third switch 330_{C21}. In addition, second compute module 140₂₂ of second die 130₂ is connectable: to first frequency line 305A via a first fuse element 325_{A22} and a first switch 330_{A22}, to second frequency line 305B via a second fuse element 325_{B22} and a second switch 330_{B22}, and to third frequency line 305C via a third fuse element 325_{C22} and a third switch 330_{C22}. Moreover, nth compute module 140_{2N} of second die 130₂ is connectable: to first frequency line 305A via a first fuse element 325_{A2N} and a first switch 330_{A2N}, to second frequency line 305B via a second fuse element 325_{B2N} and a second switch 330_{B2N}, and to third frequency line 305C via a third fuse element 325_{C2N} and a third switch 330_{C2N}.

First compute module 140_{N1} of nth die 130_{N} is connectable: to first frequency line 305A via a first fuse element 325_{AN1} and a first switch 330_{AN1}, to second frequency line 305B via a second fuse element 325_{BN1} and a second switch 330_{BN1}, and to third frequency line 305C via a third fuse element 325_{CN1} and a third switch 330_{CN1}. In addition, second compute module 140_{N2} of nth die 130_{N} is connectable: to first frequency line 305A via a first fuse element 325_{AN2} and a first switch 330_{AN2}, to second power line 305B via a second fuse element 325_{BN2} and a second switch 330_{BN2}, and to third frequency line 305C via a third fuse element 325_{CN2} and a third switch 330_{CN2}. Moreover, nth compute module 140_{NN} of nth die 130_{N} is connectable: to first frequency line 305A via a first fuse element 325_{ANN} and a first switch 330_{ANN}, to second frequency line 305B via a second fuse element 325_{BNN} and a second switch 330_{BNN}, and to third frequency line 305C via a third fuse element 325_{CNN} and a third switch 330_{CNN}.

AI processor 300 further includes mode controller 210, programming circuit 215, and programming line 220. During programming, decoder 110 may selectively switch on a corresponding switch and burn a corresponding fuse element. Burning of a fuse element may disable or disconnect a corresponding compute module from a corresponding frequency line. For example, burning first fuse element 325_{A11} of first die 130₁ disconnects first compute module 140₁₁ of first die 130₁ from first frequency line 305A. First fuse element 325_{A11} of first die 130₁ is burned by applying a programming voltage at first frequency line 305A and a gate voltage at a gate of first switch 330_{A11} and at a gate of programming circuit 215. This causes a high current to pass through first fuse element 325_{A11} thereby burning first fuse element 325_{A11}.

In example, first frequency line 305A may be programmed for a low frequency operation or a low frequency mode, second frequency line 305B may be programmed for a medium frequency operation or a medium frequency mode, and third frequency line 305C may be programmed for a high frequency operation or a high frequency mode. In a low frequency mode, each of the plurality of compute modules of each of the plurality of dies are connected to first frequency line 305A and none of the fuse elements are burned out. In the medium frequency mode, 95% of the plurality of compute modules are connected to second frequency line 305B. In addition, in the medium frequency mode, a fuse element corresponding to each of the remaining 5% of the plurality of compute modules are burned. In the high frequency mode, 80% of the plurality of compute modules are connected to third frequency line 205C. In addition, in the high frequency mode, a fuse element corresponding to each of the remaining 20% of the plurality of compute modules are burned. During the computation stage, one of first frequency line 305A, second frequency line 305B, and third frequency line 305C is selected and enabled.

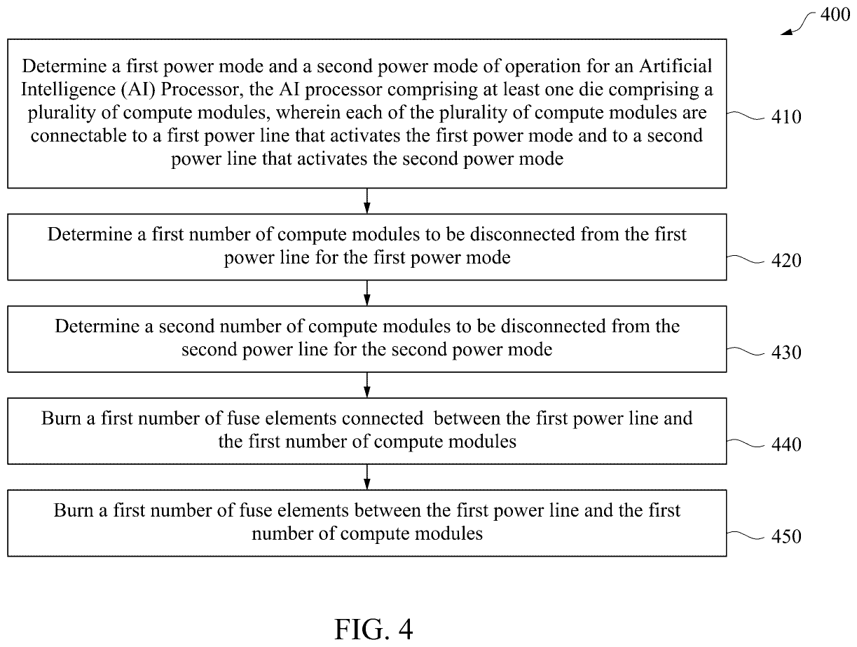

FIG. 4 is a flow diagram illustrating a method 400 for programming AI processor 200 in accordance with some embodiments. Method 400 may be performed by control circuit 105. In some examples, method 400 may be stored as instructions on a memory device, which when executed by a processor can cause the processor to perform method 400.

At stage 410 of method 400, a first power mode and a second power mode of operation for AI processor 200 is determined. As discussed above, AI processor 200 includes at least one die 130 comprising a plurality of compute modules. Each of the plurality of compute modules are connectable to first power line 205A that enables the first power mode and to second power line 205B that enables the second power mode. The first power mode can be a higher power mode and the second power mode can be a lower power mode. AI processor 200 may consume more power in the higher power mode (that is, the first power mode) compared to the lower power mode (that is, the second power mode).

At stage 420 of method 400, a first number of compute modules to be disconnected from first power line 205A for the first power mode is determined. In some examples, zero compute modules are disconnected from first power line 205A for the first power mode. In some other examples, a very small number of compute modules are disconnected from first power line 205A for the first power mode.

At stage 430 of method 400, a second number of compute modules to be disconnected from second power line 205A for the second power mode is determined. In some examples, a predetermined number of compute modules are disconnected from second power line 205A for the second power mode. The second number of compute modules to be disconnected from second power line 205A for the second power mode is greater than the first number of compute modules to be disconnected from first power line 205A for the first power mode. Hence, the second power mode is a lower power mode compared to the first power mode as lesser number of compute modules are operating the in the second power mode.

At stage 440 of method 400, a first number of fuse elements connected between first power line 205A and the first number of compute modules are burned. At stage 450 of method 400, a second number of fuse elements connected between second power line 205A and the second number of compute modules are burned. As discussed above, the fuse elements are burned by passing a high current through it.

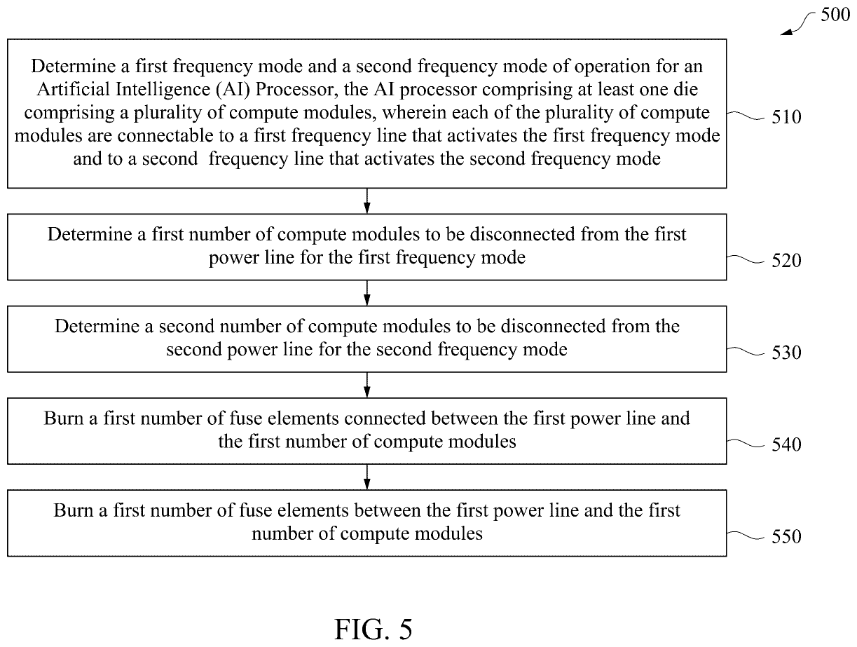

FIG. 5 is a flow diagram illustrating a method 500 for programming AI processor 300 in accordance with some embodiments. Method 500 may be performed by control circuit 105. In some examples, method 500 may be stored as instructions on a memory device, which when executed by a processor can cause the processor to perform method 500.

At stage 510 of method 500, a first frequency mode and a second frequency mode of operation for AI processor 300 is determined. As discussed above, AI processor 300 includes at least one die 130 comprising a plurality of compute modules. Each of the plurality of compute modules are connectable to first frequency line 305A that enables the first frequency mode and to second frequency line 305A that enables the second frequency mode. The first frequency is lower than the second frequency. AI processor 200 may be clocked at a higher frequency in the higher frequency mode (that is, the second frequency mode) compared to the lower frequency mode (that is, the first frequency mode).

At stage 520 of method 500, a first number of compute modules to be disconnected from first frequency line 305A for the first frequency mode is determined. In some examples, zero compute modules are disconnected from first frequency line 305A for the first frequency mode. In some other examples, a very small number of compute modules are disconnected from first frequency line 305A for the first frequency mode.

At stage 530 of method 500, a second number of compute modules to be disconnected from second frequency line 305B for the second frequency mode is determined. In some examples, a predetermined number of compute modules are disconnected from second frequency line 305B for the second frequency mode. The second number of compute modules to be disconnected from second frequency line 305B for the second frequency mode is greater than the first number of compute modules to be disconnected from first frequency line 305A for the first frequency mode. For example, some of compute modules may not be overclocked. Such compute modules are disconnected from the second frequency line.

At stage 540 of method 500, a first number of fuse elements connected between first frequency line 305A and the first number of compute modules are burned. At stage 550 of method 500, a second number of fuse elements connected between second frequency line 305B and the second number of compute modules are burned. As discussed above, the fuse elements are burned by passing a high current through it.

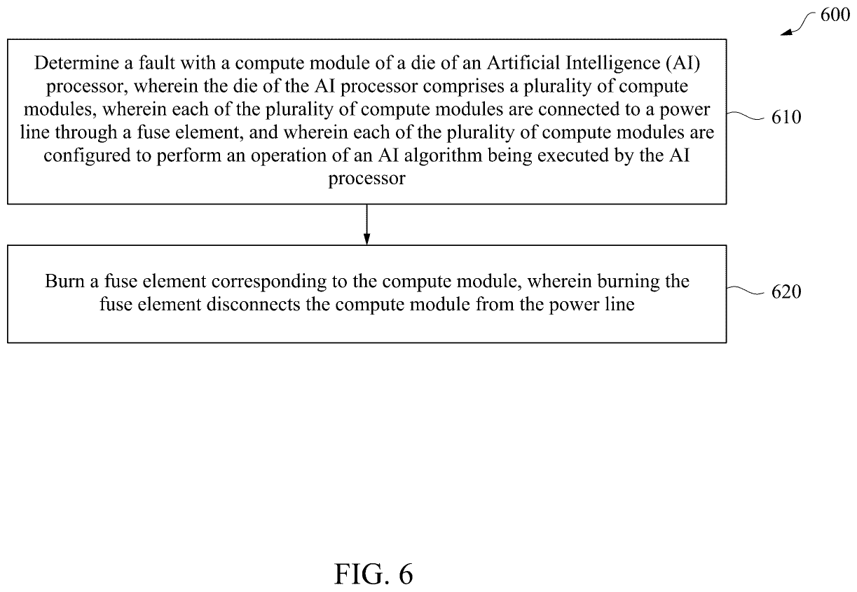

FIG. 6 is a flow diagram illustrating a method 600 for programming AI processor 100 in accordance with some embodiments. Method 600 may be performed by control circuit 105. In some examples, method 600 may be stored as instructions on a memory device, which when executed by a processor can cause the processor to perform method 600.

At stage 610 of method 600, a fault with a compute module of a die of AI processor 100. As discussed above, the die of AI processor 100 includes a plurality of compute modules. Each of the plurality of compute modules are connected to a power line through a fuse element. Each of the plurality of compute modules are configured to perform an operation of an AI algorithm being executed by the AI processor.

At stage 620 of method 600, the fuse element corresponding to the compute module is burned. Burning the fuse element disconnects the compute module from the power line thereby limiting or eliminating fault current leakage through the compute module.

In accordance with example embodiments, an AI processor comprises: a compute circuit comprising a plurality of dies, wherein each of the plurality of dies comprises a plurality of compute modules, wherein each of the plurality of compute modules are connectable to a first power line through a first fuse element and a second power line through a second fuse element; and a control circuit connected to the compute circuit, wherein the control circuit is configured to: burn a first number of first fuse elements connected between the first power line and a first number of compute modules of the plurality of compute modules, and burn a second number of second fuse elements connected between the second power line and a second number of compute modules of the plurality of compute modules.

In example embodiments, an AI processor comprises: a compute circuit comprising a plurality of dies, wherein each of the plurality of dies comprises a plurality of compute modules, wherein each of the plurality of compute modules are connectable to a first power line that activates the first power mode and to a second power line that activates the second power mode; and a control circuit connected to the compute circuit, wherein the control circuit is configured to: determine a first number of compute modules of the plurality of modules to be disconnected from the first power line for a first power mode, determine a second number of compute modules of the plurality of compute modules to be disconnected from the second power line for a second power mode, burn a first number of first fuse elements connected between the first power line and the first number of compute modules, and burn a second number of second fuse elements connected between the second power line and the second number of compute modules.

In accordance with example embodiments, a method of forming an AI processor comprises: determining a fault in a compute module of a plurality of compute modules of a compute circuit, wherein the compute circuit comprises a die comprising the plurality of compute modules, wherein each of the plurality of compute modules are connected to a power line through a fuse element, and wherein each of the plurality of compute modules are configured to perform an operation of an AI algorithm being executed by the AI processor; and burning, by a control circuit connected to the compute circuit, the fuse element connected between the power line and the compute module, wherein burning of the fuse element disconnects the compute module from the power line.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An Artificial Intelligence (AI) processor comprising:
a compute circuit comprising a plurality of dies, wherein each of the plurality of dies comprises a plurality of compute modules, and wherein each of the plurality of compute modules are connectable to a first power line through a first fuse element and a second power line through a second fuse element; and
a control circuit connected to the compute circuit, wherein the control circuit is configured to:
burn a first number of first fuse elements connected between the first power line and a first number of compute modules of the plurality of compute modules, and
burn a second number of second fuse elements connected between the second power line and a second number of compute modules of the plurality of compute modules.

2. The AI processor of claim 1, wherein the second number of compute modules are greater than the first number of compute modules.

3. The AI processor of claim 1, wherein the control circuit comprises:
a first controller configured to select the first power line and the second power line; and
a second controller configured to select the first number of first fuse elements and the second number of second fuse elements to be burned with the first controller.

4. The AI processor of claim 1, wherein burning of a first fuse element disconnects a compute module from the first power line, and wherein burning of a second fuse element disconnects a compute module from the second power line.

5. The AI processor of claim 1, wherein each of the plurality of compute modules are connectable to the first power line through a first switch and the first fuse element and to the second power line through a second switch and the second fuse element.

6. The AI processor of claim 5, further comprising:
a decoder configured to:
select the first switch connected between the first power line and each of the first number of compute modules, and
select the second switch connected between the second power line and each of the second number of compute modules; and
a mode controller configured to:
connect the first number of first fuse elements connected between the first power line and the first number of compute modules to the ground, and
connect the second number of second fuse elements connected between the second power line and the second number of compute modules to the ground.

7. The AI processor of claim 1, wherein each of the plurality of compute modules are further connectable to a third power line through a third fuse element, and wherein the control circuit is configured to burn a third number of third fuse elements connected between the third power line and a third number of compute modules of the plurality of compute modules.

8. The AI processor of claim 1, wherein the first fuse elements and the second fuse elements comprise one transistor one resistor.

9. An Artificial Intelligence (AI) processor comprising:
a compute circuit comprising a plurality of dies, wherein each of the plurality of dies comprises a plurality of compute modules, wherein each of the plurality of compute modules are connectable to a first power line that activates the first power mode and to a second power line that activates the second power mode; and
a control circuit connected to the compute circuit, wherein the control circuit is configured to:
determine a first number of compute modules of the plurality of modules to be disconnected from the first power line for a first power mode,
determine a second number of compute modules of the plurality of compute modules to be disconnected from the second power line for a second power mode,
burn a first number of first fuse elements connected between the first power line and the first number of compute modules, and
burn a second number of second fuse elements connected between the second power line and the second number of compute modules.

10. The AI processor of claim 9, wherein the AI processor consumes more power in the first power mode than the second power mode.

11. The AI processor of claim 9, wherein the second number of compute modules are greater than the first number of compute modules.

12. The AI processor of claim 9, wherein burning of a first fuse element disconnects a compute module from the first power line, and wherein burning of a second fuse element disconnects a compute module from the second power line

13. The AI processor of claim 9, wherein each of the plurality of compute modules are connectable to the first power line through a first switch and the first fuse element and to the second power line through a second switch and the second fuse element.

14. The AI processor of claim 13, further comprising:
a decoder configured to:
select the first switch connected between the first power line and each of the first number of compute modules, and
select the second switch connected between the second power line and each of the second number of compute modules; and
a mode controller configured to:
connect the first number of first fuse elements connected between the first power line and the first number of compute modules to the ground, and
connect the second number of second fuse elements connected between the second power line and the second number of compute modules to the ground.

15. The AI processor of claim 9, wherein each of the plurality of compute modules are further connectable to a third power line through a third fuse element, and wherein the control circuit is configured to burn a third number of third fuse elements connected between the third power line and a third number of compute modules of the plurality of compute modules
16. The AI processor of claim 9, wherein the first fuse elements and the second fuse elements comprise one transistor one resistor.

17. A method of forming an Artificial Intelligence (AI) processor, the method comprising:
determining a fault in a compute module of a plurality of compute modules of a compute circuit, wherein the compute circuit comprises a die comprising the plurality of compute modules, wherein each of the plurality of compute modules are connected to a power line through a fuse element, and wherein each of the plurality of compute modules are configured to perform an operation of an AI algorithm being executed by the AI processor; and
burning, by a control circuit connected to the compute circuit, the fuse element connected between the power line and the compute module, wherein burning of the fuse element disconnects the compute module from the power line.

18. The method of claim 17, wherein the fuse element comprises one transistor one resistor
19. The method of claim 17, wherein the control device is configured to program the compute circuit to operate in at least two different power modes.

20. The method of claim 17, wherein the control device is configured to program the compute circuit to operate in at least two different frequency modes.
